(19) United States
(12) Patent Application Publication
(10) Pub. No.: US 2023/0046339 A1
(43) Pub. Date: Feb. 16, 2023

(54) AGGREGATION METHOD FOR DISPATCHING WIND AND SOLAR POWER PLANTS

(71) Applicant: DALIAN UNIVERSITY OF TECHNOLOGY, Dalian (CN)

(72) Inventors: Jianjian SHEN, Dalian (CN); Yue WANG, Dalian (CN); Chuntian CHENG, Dalian (CN); Lin HU, Dalian (CN); Qiao SUN, Dalian (CN)

(21) Appl. No.: 17/881,125

(22) Filed: Aug. 4, 2022

(30) Foreign Application Priority Data
Aug. 9, 2021 (CN) 202110907833.6

(51) Int. Cl. G06Q 50/06; H02J 3/00; H02J 3/38; G06Q 10/06

(52) U.S. Cl. CPC G06Q 50/06; H02J 3/004; H02J 3/381; G06Q 10/06315; H02J 2300/24; H02J 2300/28; H02J 2203/20

(57) ABSTRACT

The present invention relates to an aggregation method for dispatching the wind and solar power plants. The primary technical solutions include: introducing the power output complementarity indexes to characterize the average effect of the degree of power output complementarity between different power stations, using cohesive hierarchical clustering to identify the optimal cluster division under different division quantities, and introducing the economic efficiency theory to determine the optimal cluster quantity, which avoids the randomness and irrationality that may result from relying on the subjective determination of the number of clusters. According to the analysis of dozens of real-world wind and solar power cluster engineering in the Yunnan Power Grid, the results show that the invention can effectively reduce the number of directly dispatched power stations, and the uncertainty of wind and solar power output can be more accurately described in a cluster manner, presenting better reliability, concentration, and practicality.

### TECHNICAL FIELD

The present invention relates to power system operations and, in particular, an aggregation method for dispatching wind and solar power plants.

### BACKGROUND

The rapid development of new energy makes the wind and solar power and other intermittent energy in the power system account for an increasing proportion, limited by wind power, photovoltaic power inherent intermittent, uncontrollable power generation characteristics, as well as other comprehensive factors, new energy consumption problems have been very prominent, especially with the rapid expansion of grid-connected scale, abandoned wind, abandoned solar and a high proportion of clean energy system stability and operation of the problem of increasing impact. From the spatial scale, clearer energy base wind, photoelectric station usually dozens, hundreds, and geographic location scattered, climate and geographical and other natural characteristics of spatial and temporal differences, making each power station into the network node, power generation characteristics are very different, facing “point more difficult to control” situation. In this case, it is exceedingly difficult to control the power generation law of a single power station and single-point command scheduling, which significantly increases the workload of schedulers and creates significant uncertainty in the generation plan for the power grid. Therefore, it is critical to reasonably divide the clusters in the cluster scheduling method that describes the output distribution characteristics of wind and photovoltaic stations using the aggregated form of multiple power stations.

At present, most of the clusters are divided considering geographic or electrical locations, cluster coupling, power utilization within clusters, etc., and the indicators of intra-cluster correlation, connectivity, scale, inter-cluster correlation, as well as the indicators of active and reactive regulating capacity, active and reactive voltage sensitivity, and supply-demand matching, which reflect the autonomous capability of clusters, are used as the basis for division. Little attention has been paid to the indicators of power plant output characteristics within clusters, as well as the indicators of the reasonableness of division among clusters, and many methods need to rely on the subjective determination of the number of clusters, which may lead to randomness and unreasonableness of results.

Given the above problems, the invention proposes a method for describing the output power of a cluster of wind and solar power stations and tests its application in the engineering context of the Yunnan power grid. The results show that the results of the invention can effectively reduce the number of directly dispatched power stations, accurately describe the uncertain output of wind and solar power, and present better reliability, concentration and practicality.

### SUMMARY

The technical problem to be solved by the present invention is to provide an aggregation method for dispatching wind and solar power plants to reduce the number of directly dispatched power stations and to improve the reliability, concentration and practicality of uncertain power output description of the wind and solar power station.

Technical solutions of the invention.

An aggregation method for dispatching wind and solar power plants includes the following steps.

step (1) introduces the complementarity index S to reflect the average effect of power plant cluster output complementarity, the calculation formula follows:

$$\{ \begin{matrix}S = {\sum }_{q = 1}^{Q} {E}_{δ}^{q} / Q \\ {E}_{δ}^{q} = \frac{1}{I - 1} {\sum }_{i = 1}^{I - 1} {β}_{q , i} \\ {β}_{q , i} = \vert {{\sum }_{n = 1}}^{N} {δ}_{q , n , i} \vert \\ {δ}_{q , n , i} = \frac{{P}_{q , n , i + 1} - {P}_{q , n , i}}{T}\end{matrix} ; \qquad ( 1 )$$

where E_{δ}^{q} indicates the average effect of the complementary degree of each power station in cluster q in a period, the smaller the E_{δ}^{q}, the higher the degree of the complementary power output of each power station, and the larger the E₆₇ ^{q}, the lower the degree of the complementary power output of each power station; β_{q,i} is the degree of non-complementarity of each power station in cluster q at moment i, β_{q,i}=0, indicating that the power output changes of each power station in cluster q exactly cancel out and reach complete complementarity, β_{q,i}≠0, indicating the existence of unbalanced power output; δ_{q,n,i} indicates the rate of change of power output of station n in cluster q at moment i; I is the number of sampling points; P_{q,n,i} and P_{q,n,i+1} indicate the power output of station n at moments i and i+1, respectively; T is the period of the rate of change of power output; Q indicates the number of clusters; N indicates the number of plants.

step (2) constructs a power plant clustering method based on cohesive hierarchical clustering, takes the actual power output process of each power plant as the characteristic input, uses this complementarity index in step (1) as the evaluation criterion, and uses combination theory and hierarchical iteration to determine the optimal power plant cluster division; the specific steps are as follows:

step 2.1. input the power output process sequence of the N power station.

step 2.2. The number of possible clusters of N power stations is 1,2, . . . , N; when the number of clusters is N, there is only one way to divide them, i.e., each power station as a cluster individually; when the number of clusters is 1, there is also only one way to divide them, i.e., all power stations as a cluster; when the number of clusters lies between 2 and N−1, it is necessary to cluster by cohesive hierarchy the results of each layer to obtain the optimal way of dividing power plant clusters and their corresponding indicators of this complementarity.

In the first layer of cohesive hierarchical clustering, the initial number of clusters is N. The number of clusters is changed from N to N−1 by converging the two power plants with the highest degree of complementarity of output as one cluster. Specifically, using mathematical combination theory, all combination methods facing a cluster of power plants are generated, and the complementarity index corresponding to each combination method is calculated according to Equation (1).

$$\{ \begin{matrix}c {m}_{1}^{N - 1} \to {S}_{N - 1 , 1} \\ c {m}_{2}^{N - 1} \to {S}_{N - 1 , 2} \\ ⋯ \\ c {m}_{g}^{N - 1} \to {S}_{N - 1 , g} \\ ⋯ \\ c {m}_{G}^{N - 1} \to {S}_{N - 1 , G}\end{matrix} ;$$

where g is the number of the combination; G is the total number of all combinations, G=N(N−1)/2; cm_{g}^{N-1} indicates the gth combination when the number of clusters is N−1; S_{N-1,g} indicates the complementarity index corresponding to the gth combination when the number of clusters is N−1.

step 2.3. When the number of clusters is N−1, the minimum value of this complementarity indicator is:

$${S}_{m i n}^{N - 1} = {min}_{g = 1 , 2 … G} {S}_{N - 1 , g} ;$$

step 2.4. Assuming that the combination of Sₘᵢₙ^{N-1} corresponds to cm_{g*}^{N-1}, the number of clusters is changed from N to N−1 according to the combination of clusters.

step 2.5. Repeat step 2.2-step 2.4 until all power plants converge into 2 clusters; through hierarchical iterative calculation, the optimal power plant cluster division and the corresponding complementarity index can be obtained when the number of clusters is 2 to N−1.

The optimal power plant clustering method and its complementarity index corresponding to the number of all possible cluster divisions is expressed as:

$$\{ \begin{matrix}c {m}_{{g}^{*}}^{1} \to {S}_{m i n}^{1} \\ c {m}_{{g}^{*}}^{2} \to {S}_{m i n}^{2} \\ … \\ c {m}_{{g}^{*}}^{N} \to {S}_{m i n}^{N}\end{matrix} ;$$

step (3) introduces benefit indicators to determine the optimal number of cluster divisions, the specific steps are as follows:

step 3.1 defines revenue as the degree of decrease in the complementarity index and cost as the degree of increase in the number of clusters, calculated as follows.

$$\begin{matrix}{ε}_{{n}^{′}} = \frac{{S}_{m a x} - {S}_{m i n}^{{n}^{′}}}{{S}_{m a x} - {S}_{m i n}} \\ {δ}_{{n}^{′}} = \frac{{n}^{′} - {n}_{m i n}^{′}}{{n}_{m a x}^{′} - {n}_{m i n}^{′}}\end{matrix} ;$$

where ε_{n′} indicates the degree of reduction of the complementarity index when the number of clusters is n′. δ_{n′} indicates the degree of increase in the number of clusters when the number of clusters is n′. Sₘₐₓ, Sₘᵢₙ indicate the maximum and minimum values of the complementarity index, Sₘₐₓ=max(Sₘᵢₙ¹,Sₘᵢₙ², . . . , Sₘᵢₙ^{N}), Sₘᵢₙ=min(Sₘᵢₙ¹,Sₘᵢₙ², . . . , Sₘᵢₙ^{N}), respectively. n′ₘₐₓ, n′ₘᵢₙ indicate the maximum and minimum values of the number of clusters, n′ₘₐₓ=N, n′ₘᵢₙ=1, respectively.

step 3.2. calculating the benefit e_{n′} based on revenue and cost with the following formula.

e_{n′}=ε_{n′}−δ_{n′};

step 3.3. identifying the number of clusters that corresponds to the maximum benefit n* as the final number of clusters.

The results of the present invention have the following beneficial effects: compared with the single power station dispatching method, the cluster dispatching method of the present invention can effectively reduce the number of directly dispatched power stations, accurately describe the uncertain output of wind and solar power stations, and present better reliability, concentration and practicality. The complementarity index essentially refers to the average effect of the complementary degree of each power plant in a certain period. By minimizing the complementarity index, the optimal cluster division is determined to reduce the volatility of the wind and solar power cluster output and make the cluster output smoother. The introduction of economic benefits to determine the number of cluster divisions avoids the randomness and unreasonableness of relying on subjectivity to determine the number of clusters.

### DESCRIPTION OF DRAWINGS

FIG. 1 is a diagram of the general solution framework of the method of the invention.

FIG. 2 shows the schematic diagram of the power plant aggregation method.

FIG. 3 shows a schematic diagram for determining the number of clusters of power stations to be divided.

FIG. 4 shows the curve of complementarity indicators about the number of cluster divisions.

FIG. 5 shows the average daily output curve for each cluster.

FIG. 6 shows the convergence process of the scheme 1 power plant.

FIG. 7A and FIG. 7B show the daily output processes of photovoltaic plants on sunny and cloudy days, respectively.

FIG. 8A and FIG. 8B show the power output process of each plant within the photovoltaic power plant cluster.

FIG. 9 shows the variation curve of the average power output rate for each cluster of scheme 3.

FIG. 10A and FIG. 10B show the cluster reliability and concentration of wind power plants, respectively.

FIG. 11A and FIG. 11B show the reliability and concentration of PV plant clusters, respectively.

FIG. 12A and FIG. 12B show the reliability and concentration of the hybrid cluster of wind and solar power, respectively.

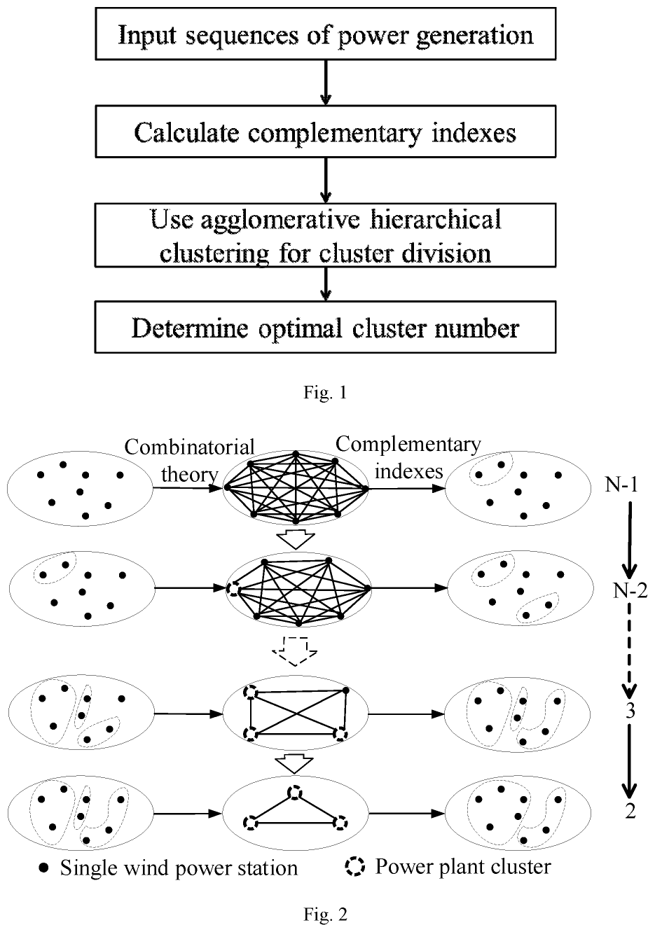

### DETAILED DESCRIPTION

The specific embodiments of the invention are further described below in conjunction with the accompanying drawings and technical solutions.

Generally speaking, cluster scheduling of wind and solar power stations can effectively reduce the number of directly dispatched power stations, and at the same time, the smoothness of cluster output power can be improved by taking advantage of the spatial and temporal complementary characteristics between power sources. To measure the degree of output complementarity between power plants, the complementarity index S is introduced to reflect the average effect of power plant cluster output complementarity.

$$\{ \begin{matrix}S = {\sum }_{q = 1}^{Q} {E}_{δ}^{q} / Q \\ {E}_{δ}^{q} = \frac{1}{I - 1} {\sum }_{i = 1}^{I - 1} {β}_{q , i} \\ {β}_{q , i} = \vert {\sum }_{n = 1}^{N} {δ}_{q , n , i} \vert \\ {δ}_{q , n , i} = \frac{{P}_{q , n , i + 1} - {P}_{q , n , i}}{T}\end{matrix} \qquad ( 7 )$$

where E_{δ}^{q} indicates the average effect of the complementary degree of each power station in cluster q in a certain period, the smaller the E_{δ}^{q}, the higher the degree of the complementary power output of each power station, and the larger the E_{δ}^{q}, the lower the degree of the complementary power output of each power station; β_{q,i} is the degree of non-complementarity of each power station in cluster q at moment i , β_{q,i}=0, indicating that the power output changes of each power station in cluster q exactly cancel out and reach complete complementarity; β_{q,i}≠0, indicating the existence of unbalanced power output; δ_{q,n,i} indicates the rate of change of the output of power station n in cluster q at the moment; I is the number of sampling points; P_{q,n,i} and P_{q,n,i+1} indicate the output of power station n at the moment i and i+1, respectively; T is the period of the rate of change of output; Q indicates the number of clusters; N indicates the number of power stations.

To determine the suitable clusters of new energy plants, two problems need to be solved: (1) determine the number of clusters; (2) determine the optimal way to divide the clusters under this number of clusters. Since the number of clusters cannot be predicted, we first determine the optimal number of clusters corresponding to any possible number of clusters, and then determine the optimal number of clusters based on the two-dimensional variation curve of the complementarity index and the number of clusters.

The goal of power station clustering is to allocate power stations with better output complementarity to the same group. To determine the optimal clustering method under a certain number of clusters, a cohesive hierarchical clustering-based power station clustering method is constructed, using the actual output process of each power station as the characteristic input and the above complementarity index as the evaluation criterion, using combination theory and hierarchical iteration to determine the optimal clustering method, and its principle See FIG. 2.

Assuming that the study includes N new energy plants, the number of possible clusters is: 1,2, . . . , N . When the number of clusters is N, there is only one way to divide them, i.e., each power station as a cluster individually; similarly, when the number of clusters is 1, there is only one way to divide them, i.e., all power stations as a cluster; when the number of clusters lies between 2 and N−1, the optimal way to divide the clusters and the corresponding complementarity indexes need to be obtained by the results of each layer of hierarchical clustering.

As shown in FIG. 2, in the first layer of cohesive hierarchical clustering, the initial number of clusters is N, and the overall number of clusters in the system changes from N to N−1 by converging the two power stations with the highest degree of complementary power output as one cluster. The specific idea is to apply the mathematical combination theory to generate all the combination methods facing the power plant cluster, and to calculate this complementarity index corresponding to each combination method according to Equation (7).

$$\{ \begin{matrix}c {m}_{1}^{N - 1} \to {S}_{N - 1 , 1} \\ c {m}_{2}^{N - 1} \to {S}_{N - 1 , 2} \\ … \\ c {m}_{g}^{N - 1} \to {S}_{N - 1 , g} \\ … \\ c {m}_{G}^{N - 1} \to {S}_{N - 1 , G}\end{matrix} \qquad ( 8 )$$

where g is the number of combinations; G is the total number of all combination modes, G=N(N−1)/2; cm_{g}^{N-1} indicates the gth combination mode when the number of clusters is N−1; S_{N-1,g} indicates the complementarity index of the gth combination mode when the number of clusters is N−1 .

when the number of clusters is N−1, the minimum value of this complementarity indicator is:

$${S}_{m i n}^{N - 1} = {min}_{g = 1 , 2 … G} {S}_{N - 1 , g} \qquad ( 9 )$$

assuming that the combination of Sₘᵢₙ^{N-1} corresponds to cm_{g*}^{N-1}, the number of clusters is changed from N to N−1 according to the combination of clusters. Repeat the above process until all power stations converge into 2 clusters. The optimal power plant clustering method and the corresponding complementarity index for the number of clusters from 2 to N−1 can be obtained through hierarchical iterative calculations.

In summary, the optimal power plant clustering method and its complementarity index corresponding to the number of all possible cluster divisions is expressed as

$$\{ \begin{matrix}c {m}_{{g}^{*}}^{1} \to {S}_{m i n}^{1} \\ c {m}_{{g}^{*}}^{2} \to {S}_{m i n}^{2} \\ … \\ c {m}_{{g}^{*}}^{N} \to {S}_{m i n}^{N}\end{matrix} \qquad ( 10 )$$

For power plant cluster scheduling, fewer clusters mean fewer objects are directly dispatched by the grid, so reducing the number of clusters can significantly reduce the workload of schedulers and increase the practicality of cluster scheduling. However, as the power stations continue to converge, the similarity of power output patterns among some of the power stations will lead to a greater degree of non-complementarity and reduced complementarity among the power stations in the cluster, so it is very important to choose the right number of clusters.

The concept of economic efficiency is introduced to determine the optimal number of clusters. Typically, the benefit is the difference between revenue and cost. In the present invention, the degree of reduction of the complementarity index is the revenue and the degree of increase of the number of clusters is the cost. The calculation formula is as follows.

$$\begin{matrix}{ε}_{{n}^{′}} = \frac{{S}_{m a x} - {S}_{m i n}^{{n}^{′}}}{{S}_{m a x} - {S}_{m i n}} \\ {δ}_{{n}^{′}} = \frac{{n}^{′} - {n}_{m i n}^{′}}{{n}_{m a x}^{′} - {n}_{m i n}^{′}}\end{matrix} \qquad ( 11 )$$

where: ε_{n′} indicates the degree of reduction of the complementarity index when the number of clusters is n′. δ_{n′} indicates the degree of increase in the number of clusters when the number of clusters is n′; Sₘₐₓ,Sₘᵢₙ indicate the maximum and minimum values of the complementarity index, respectively. Sₘₐₓ=max(Sₘᵢₙ¹,Sₘᵢₙ², . . . , Sₘᵢₙ^{N}), Sₘᵢₙ=min(Sₘᵢₙ¹,Sₘᵢₙ², . . . , Sₘᵢₙ^{N}). n′ₘₐₓ, n′ₘᵢₙ indicate the maximum and minimum values of the number of clusters, n′ₘₐₓ=N, n′ₘᵢₙ32 1, respectively.

The formula for calculating the benefits is as follows.

e_{n′}=ε_{n′}−δ_{n′} (12)

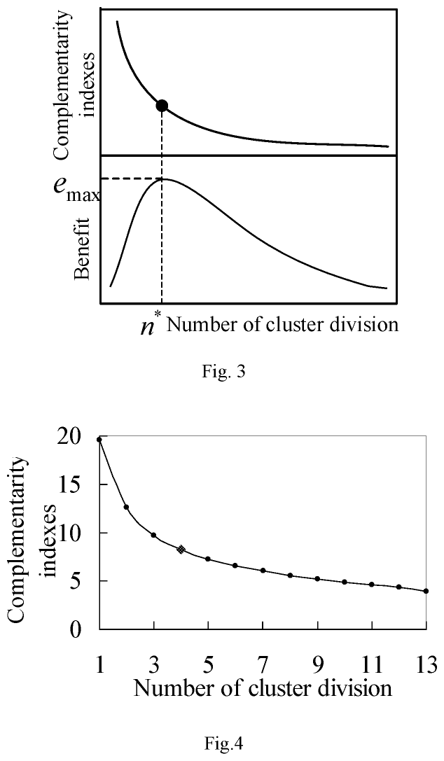

Identify the number of clusters that corresponds to the maximum benefit n* as the final number of clusters. When the number of clusters is less than n*, the complementarity index decreases significantly; when the number of clusters is greater than n*, the complementarity index tends to be stable, so n* is the appropriate number of clusters, and its schematic diagram is shown in FIG. 3.

Application Examples:

The method is now validated with 21 wind and photovoltaic stations in a region of Yunnan, where the actual and planned output data from 2017-2018 are used to construct the model, and the data from January 2019 are used for testing, with a time scale of 15 min. Considering the characteristics of PV plant night stop and day hair, the data from 8:00 to 19:00 are extracted for analysis. To verify the applicability of the method of the invention to different clusters of power plants, three hybrid schemes of power plant clusters are constructed, scheme 1 is a single wind power plant cluster, scheme 2 is a single photovoltaic power plant cluster, and scheme 3 is a mixed cluster of wind and solar power plants, where scheme 1 includes 13 wind power plants (W1-W13), scheme 2 includes 8 photovoltaic power plants (S1-S8), and scheme 3 includes all the power plants in schemes 1 and 2 power plants in Scenarios 1 and 2.

The sample data were processed into D×T dimensional matrix (D is the number of days and T is the daily sampling points) and the clusters were divided into three scenarios separately using the method of the present invention, and the results are shown in Table 1 It can be seen that the number of clusters divided into different schemes and the number of power plants included in the clusters differ significantly, which is closely related to the power output characteristics of wind and solar power plants.

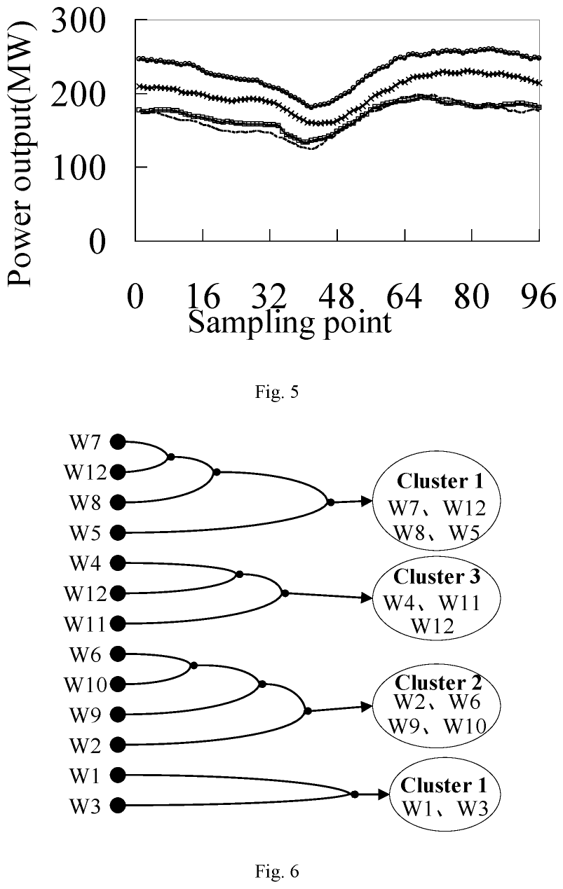

For Scheme 1, the relationship curve between the complementary index and the number of clusters in FIG. 4 shows that as the number of clusters decreases, the complementary index increases, and when the number of clusters is 4, the change rate of the index is in a critical state so that all power stations converge into 4 clusters, which can also be analyzed by the curve of the output process of each cluster in FIG. 5, and the trend of the output process of the 4 clusters is basically the same. If the convergence continues, the similar output pattern of each cluster may lead to a significant increase in the degree of non-complementarity, so the number of clusters of wind power plants and the power plants included in Scheme 1 is suitable. Further analysis of the process of convergence of power stations (FIG. 6) shows that the two power stations with the highest degree of complementarity, W7, and W12, are preferentially converged into one cluster, i.e. the first level of cohesive hierarchical clustering, with a degree of complementarity of 3.31, corresponding to a complementarity index of 4.31, guided by the output complementarity index. In this way, the final degrees of complementarity for the four clusters were obtained as 9.20, 8.98, 7.51, and 7.25, respectively. To demonstrate the superiority of this cluster partitioning state, power stations are randomly removed and moved into other clusters to compare the changes in the degree of complementarity. For example, the degree of complementarity between W1 and W3 in cluster 1 is 9.20, and if W1 is moved into other clusters, the degree of complementarity between W1 and clusters 2, 3 and 4 is 11.36, 9.85 and 9.66, respectively. Similarly, if we move into W3, the degree of complementarity is 11.27, 9.70, and 9.53, respectively, and it is clear that both cluster approaches are less complementary than the convergence of W1 and W3. Similar conclusions can be obtained when other power stations are selected for testing, indicating that the cluster partitioning results obtained in Scheme 1 are optimal.

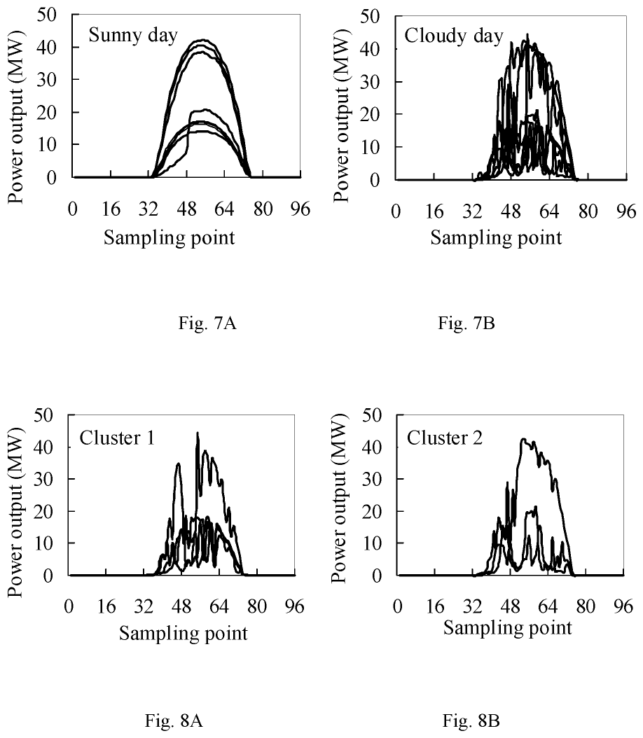

For Scheme 2, the convergence process of photovoltaic power plants is mainly based on the power output data from 8:00-19:00. According to the analysis of actual data, the power output characteristics of each photovoltaic power plant on sunny and cloudy days are quite different. On sunny days, the power plants' output trends are basically consistent, see FIG. 7A; however, on cloudy days, the power processes of PV plants fluctuate more frequently and the trends are not consistent among plants, see FIG. 7B, and this situation mostly reflects better complementarity. For example, FIG. 8A and FIG. 8B show the output process curves of each power station in Cluster 1 and Cluster 2 on cloudy days, and it can be seen that the power output of each power station in the cluster shows good complementarity due to the inconsistent fluctuation pattern. In addition, cluster 3 contains only one power station S3, the reason is that this power station has low complementarity of output with other power stations. If S3 is moved into the other two clusters, the degree of non-complementarity will be greatly increased and the degree of complementarity of clusters 1 and 2 will change from 2.55 and 2.25 to 3.55 and 3.31 respectively, so it is reasonable to treat S3 as a separate cluster.

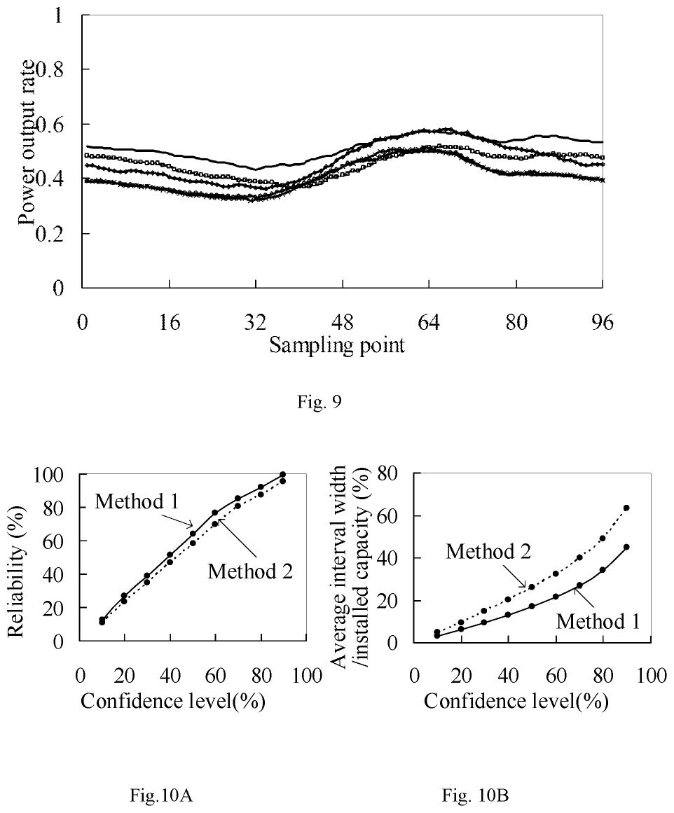

For Scheme 3, because of the natural temporal complementarity of wind and solar power generation, each cluster obtained includes both wind and solar power plants, and the output complementarity between the same type of power plants within each cluster and between different types of power plants is optimal. As can be seen from the average output rate variation curves of each cluster in FIG. 9, the process of output variation after convergence is indeed smoother, reflecting a better complementarity. In addition, the convergence output curve of each cluster has approximately the same trend, indicating that the complementarity between clusters is poor and it is not appropriate to continue convergence, which verifies the reasonableness of the number of cluster divisions.

The common method is used to establish the probability distribution of power output for each cluster. Based on the probability density distribution of power output, the variation interval of power output under different confidence levels can be analyzed, and then the accuracy of the distribution law can be evaluated. The first is to evaluate whether the probability distribution is reliable, expressed by the probability of the actual value falling into the interval of the output change; the second is to analyze the concentration of the probability distribution, i.e., the width of the interval, the narrower the interval, the more concentrated the uncertainty information and the stronger the utility.

The confidence interval is selected based on the principle of minimum width, and assuming that the upper and lower confidence intervals for the output of each period are [p̅₁,p̅₂, . . . , p̅_{T}] and [p₁,p₂, . . . , p_{T}] respectively, the average interval width is:

$$d = \frac{1}{T} {\sum }_{t = 1}^{T} ( {\overline{p}}_{t} - {\underline{p}}_{t} ) \qquad ( 13 )$$

where: d indicates the width of the mean interval; p̅ₜ, pₜ indicate the upper and lower confidence interval limits of period t, respectively.

Reliability is calculated using equation (12).

$${R}_{1 - β} = \frac{{n}_{1 - β}}{N} \times 100 \% \qquad ( 14 )$$

where: R_{1-β} is the reliability value at confidence level 1−β; N is the number of samples; n_{1-β} is the number of actual output values falling into the confidence interval with a confidence level 1−β. The closer R_{1-β} is to 1, the higher the reliability.

Due to the large number of power station clusters, the following focuses on selecting typical power station clusters 4, 1 and 1 in schemes 1, 2 and 3 for evaluation and analysis. For convenience, the method of the present invention is noted as Method 1, and is compared with no division of clusters and each power station is modeled separately with a probability distribution, and is noted as Method 2.

FIG. 10A and FIG. 10B give the relationship between the different confidence levels of the wind power plant group and the reliability of the output description and the width of the average interval. It can be seen that method 1 has higher reliability, with a reliability of 99.3% at 90% confidence interval. In terms of the size of the output interval, method 2 is larger because of the large randomness and less regularity of the output of individual wind power plants.

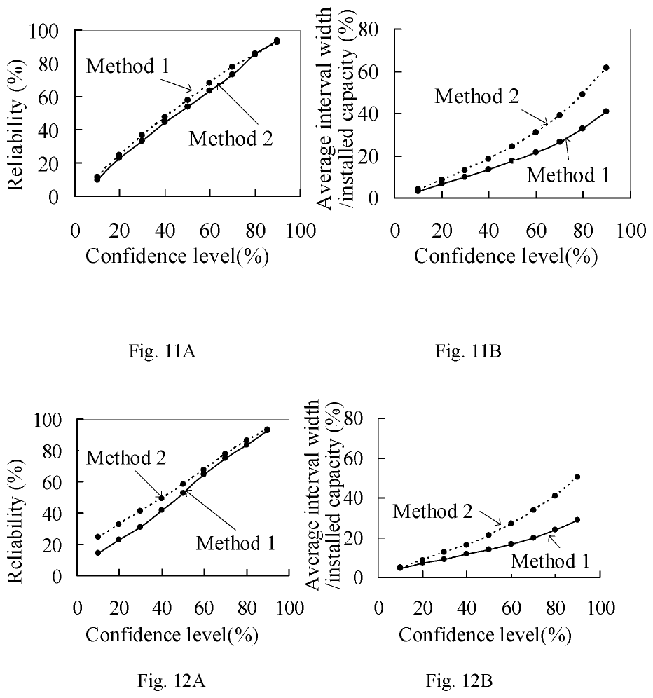

FIG. 11A and FIG. 11B give the relationship between the different confidence levels of the PV plant clusters and the reliability of the output description and the width of the average interval. Unlike the wind power plant clusters obviously, the overall reliability of the two methods is similar, and the average interval width of method 1 is smaller, indicating that the photovoltaic plants show a stronger clustering effect and a stronger regularity of cluster output compared to individual plants.

FIG. 12A and FIG. 12B give the relationship between the different confidence levels of the hybrid cluster of wind and solar power and the reliability of the output description and the width of the average interval. It can be seen that method 2 is more reliable, but the width of its confidence interval is significantly larger than that of method 1, which is less practical. Method 1 has high reliability and great concentration.

Through the comparison and analysis of different methods and schemes, it is verified that the proposed method of describing the zonal convergence output of wind and solar power stations can be applied to different kinds of power stations, and the reliability of the results is high and the uncertainty is small, which can effectively reduce the scale of the wind and solar power uncertainty output model while ensuring the accuracy.

TABLE 1
Cluster division results

| | | Number | | | |
|---|---|---|---|---|---|
| | Cluster | of | | Installed | |
| | serial | power | | capacity | Complementarity |
| Scheme | number | stations | Includes power stations | (MW) | indicators |
| Scheme 1 | Cluster 1 | 2 | W1 [symbol] W3 | 333 | 8.23 |
| | Cluster 2 | 4 | W2 [symbol] W6 [symbol] W9 [symbol] W10 | 380 | |
| | Cluster 3 | 3 | W4 [symbol] W11 [symbol] W13 | 343.4 | |
| | Cluster 4 | 4 | W5 [symbol] W7 [symbol] W8 [symbol] W12 | 349.6 | |
| Scheme 2 | Cluster 1 | 4 | S1 [symbol] S4 [symbol] S5 [symbol] S8 | 110.0 | 4.72 |
| | Cluster 2 | 3 | S2 [symbol] S6 [symbol] S7 | 97.0 | |
| | Cluster 3 | 1 | S3 | 50.0 | |
| Scheme 3 | Cluster 1 | 7 | W4 [symbol] W5 [symbol] W6 [symbol] W8 [symbol] S4 [symbol] | 520.6 | 7.14 |
| | | | S5 [symbol] S7 | | |
| | Cluster 2 | 5 | W9 [symbol] W11 [symbol] W12 [symbol] S3 [symbol] S6 | 359.9 | |
| | Cluster 3 | 3 | W1 [symbol] W13 [symbol] S1 | 307 | |
| | Cluster 4 | 3 | W3 [symbol] W10 [symbol] S2 | 220 | |
| | Cluster 5 | 3 | W2 [symbol] W7 [symbol] S8 | 255.5 | |

1. An aggregation method for dispatching wind and solar power plants, characterized in that it includes the following steps:
step (1) introducing a complementarity index S to characterize an average effect of power output complementarity; a calculation formula follows:
$$\{ \begin{matrix}S = {\sum }_{q = 1}^{Q} {E}_{δ}^{q} / Q \\ {E}_{δ}^{q} = \frac{1}{I - 1} {\sum }_{i = 1}^{I - 1} {β}_{q , i} \\ {β}_{q , i} = \vert {\sum }_{n = 1}^{N} {δ}_{q , n , i} \vert \\ {δ}_{q , n , i} = \frac{{P}_{q , n , i + 1} - {P}_{q , n , i}}{T}\end{matrix} ; \qquad ( 1 )$$
where: E_{δ}^{q} indicates the average effect of the complementary degree of each power station in cluster q in a certain period, a smaller the E_{δ}^{q}, a higher the degree of the complementary power output of each power station, and a larger the E_{δ}^{q}, a lower the degree of the complementary power output of each power station; β_{q,i} is a degree of non-complementarity of each power station in cluster q at moment i, β_{q,i}=0, indicating that the power output changes of each power station in cluster q exactly cancel out and reach complete complementarity, β_{q,i}≠0, indicating a existence of unbalanced power output; δ_{q,n,i} indicates a rate of change in the output of power station n in cluster q at moment i; I is a number of sampling points; P_{q,n,i} and P_{q,n,i+1} indicate the output of power station n at moments i and i+1, respectively; T is a period of the rate of change of output; Q indicates a number of clusters; N indicates a number of power stations;
step (2) developing a division method of power plant clusters based on cohesive hierarchical clustering, taking an actual power output process of each power plant as the characteristic input, using this complementarity index in step (1) as the evaluation criterion, and using a combination theory and hierarchical iteration to determine the optimal power plant cluster division; a specific steps are as follows;
step 2.1. inputting the power output process sequence of N power plants;
step 2.2. a number of possible clusters of N power stations is: 1,2, . . . , N; when the number of clusters is N, there is only one way to divide them, i.e., each power station as a cluster individually; when the number of clusters is 1, there is also only one way to divide them, i.e., all power stations as a cluster; when the number of clusters lies between 2 and N−1, it is necessary to cluster by cohesive hierarchy the results of each layer to obtain a optimal way of dividing power plant clusters and its corresponding indicators of this complementarity;
in a first layer of cohesive hierarchical clustering, an initial number of clusters is N; the number of clusters is changed from N to N−1 by converging the two power plants with a highest degree of complementarity of output as one cluster; specifically, using mathematical combination theory, all combination methods facing a cluster of power plants are generated, and that complementarity index corresponding to each combination method is calculated according to Equation (1):
$$\{ \begin{matrix}c {m}_{1}^{N - 1} \to {S}_{N - 1 , 1} \\ c {m}_{2}^{N - 1} \to {S}_{N - 1 , 2} \\ … \\ c {m}_{g}^{N - 1} \to {S}_{N - 1 , g} \\ … \\ c {m}_{G}^{N - 1} \to {S}_{N - 1 , G}\end{matrix} ;$$
where g is a number of the combinations; G is a total number of all combinations, G=N(N−1)/2; cm_{g}^{N-1} indicates a gth combination when the number of clusters is N−1; S_{N-1,g} indicates the complementarity index corresponding to the gth combination when the number of clusters is N−1;
step 2.3. when the number of clusters is N−1, the minimum value of this complementarity index is:
$${S}_{m i n}^{N - 1} = {min}_{g = 1 , 2 … G} {S}_{N - 1 , g} ;$$
step 2.4. assuming that the combination of Sₘᵢₙ^{N-1} corresponds to cm_{g*}^{N-1}, the number of clusters is changed from N to N−1 according to the combination of clusters;
step 2.5. repeating step 2.2-step 2.4 until all power stations converge into two clusters; the optimal power plant clustering method and the corresponding complementarity index for the number of clusters from 2 to N−1 is obtained through hierarchical iterative calculations;
the optimal power plant clusters method and its complementarity index corresponding to the number of all possible cluster divisions is expressed as:
$$\{ \begin{matrix}c {m}_{{g}^{*}}^{1} \to {S}_{m i n}^{1} \\ c {m}_{{g}^{*}}^{2} \to {S}_{m i n}^{2} \\ … \\ c {m}_{{g}^{*}}^{N} \to {S}_{m i n}^{N}\end{matrix} ;$$
step (3) introducing benefit indicators to determine the optimal number of cluster divisions; the specific steps are as follows:
step 3.1 defining revenue as the degree of decrease in the complementarity index and cost as the degree of increase in the number of clusters, calculated as follows:
$$\begin{matrix}{ε}_{{n}^{′}} = \frac{{S}_{m a x} - {S}_{m i n}^{{n}^{′}}}{{S}_{m a x} - {S}_{m i n}} \\ {δ}_{{n}^{′}} = \frac{{n}^{′} - {n}_{m i n}^{′}}{{n}_{m a x}^{′} - {n}_{m i n}^{′}}\end{matrix} ;$$
where ε_{n′} indicates a degree of reduction of the complementarity index when the number of clusters is n′; δ_{n′} indicates a degree of increase in the number of clusters when the number of clusters is n′; Sₘₐₓ, Sₘᵢₙindicate a maximum and minimum values of the complementarity index, Sₘₐₓ=max(Sₘᵢₙ¹,Sₘᵢₙ², . . . , Sₘᵢₙ^{N}), Sₘᵢₙ=min(Sₘᵢₙ¹,Sₘᵢₙ², . . . , Sₘᵢₙ^{N}), respectively; n′ₘₐₓ, n′ₘᵢₙ indicate a maximum and minimum values of the number of clusters, n′ₘₐₓ=N, n′ₘᵢₙ=1, respectively;
step 3.2. calculating the benefit e_{n′} based on revenue and cost with the following formula:
e_{n′}=ε_{n′}−δ_{n′};
Step 3.3. identifying the number of clusters that corresponds to the maximum benefit n* as the final number of clusters.
